(19) United States
(12) Patent Application Publication
(10) Pub. No.: US 2007/0218910 A1
(43) Pub. Date: Sep. 20, 2007

(54) Dynamic beam steering of backhaul traffic

(75) Inventors: Thomas C. Hill, Crystal Lake, IL (US); Jeff S. Anderson, Itasca, IL (US); Brian K. Classon, Palatine, IL (US); Michael D. Kotzin, Buffalo Grove, IL (US); Sivakumar Muthuswamy, Tower Lakes, IL (US); Joseph J. Schuler, Roselle, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC.

(21) Appl. No.: 11/376,280

(22) Filed: Mar. 15, 2006

(51) Int. Cl. H04Q 7/20

(52) U.S. Cl. 455/445

(57) ABSTRACT

A communication system and a method of communicating backhaul data. The communication system can include a controller. The controller can dynamically select from a plurality of backhaul sites at least a first backhaul site to establish a backhaul communication link with an access point. The controller also can generate a control signal that indicates to the access point to beam steer a backhaul signal to the first backhaul site. The access point can include a phased array that dynamically beam steers the backhaul signal in azimuth and elevation.

### BACKGROUND OF THE INVENTION

1. Field of the Invention

The present invention generally relates to wireless communication systems and, more particularly, to implementation of wireless backhauls.

2. Background of the Invention

Contemporary wireless communication systems often include one or more access points communicatively linked to a backhaul site to provide a communication path between a communication device, such as a personal communication device, and another network device, such as a wide area network (WAN) server. Oftentimes the access point will communicate with the backhaul site using a wireless backhaul. Use of the wireless backhaul eliminates the need to install wire or fiber optic cables between the access point and the backhaul site, thereby reducing network installation and maintenance costs.

Unfortunately, wireless backhauls are allocated only a limited amount of RF bandwidth. While the bandwidth allocation may be sufficient when only a few devices are communicating via a particular access point, under high network traffic conditions the bandwidth allocation may be insufficient to maintain optimum data transmission rates. In consequence, communication activities, such as downloading files from a server, may suffer.

### SUMMARY OF THE INVENTION

The present invention relates to a method of communicating backhaul data. The method can include dynamically selecting a first backhaul site to establish a backhaul communication link with an access point. The first backhaul site can be selected from a plurality of backhaul sites that are each configured to wirelessly communicate with the access point. The method also can include dynamically beam steering backhaul signals communicated between the access point and the backhaul site.

The present invention also relates to a communication system. The communication system can include an access point. The access point can include a phased array that dynamically beam steers backhaul signals. The communication system also can include a controller and a plurality of backhaul sites that are each configured to wirelessly communicate with the access point. The controller can dynamically select from the plurality of backhaul sites at least a first backhaul site to establish a backhaul communication link with the access point. The controller also can generate a control signal that indicates to the access point to beam steer a backhaul signal to the first backhaul site.

Another embodiment of the present invention can include a machine readable storage being programmed to cause a machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a wireless communication system that is useful for understanding the present invention;

FIG. 2 depicts an access point that is useful for understanding the present invention;

FIG. 3 depicts a front view of a phased array that is useful for understanding the present invention;

FIG. 4 depicts a backhaul site that is useful for understanding the present invention; and

FIG. 5 depicts a flowchart presenting a communication method that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The inventive arrangements disclosed herein relate to dynamic allocation of spatially diverse backhaul channels for supporting backhaul communications between access points and backhaul sites. For example, an access point can dynamically select a particular backhaul site with which to communicate backhaul signals, and focus backhaul signals to the selected backhaul site by beam steering the backhaul signals both in azimuth and in elevation. In addition, spatial and polarization diversity can be implemented to support such communications. The allocation scheme can be based on the available bandwidth of the individual backhaul sites, relative priority of communication signals, communication traffic patterns, geometrical patterns formed by nodes of the communications network, collective needs of the communications network, and/or any other parameters that may affect the desired manner in which network resources are allocated.

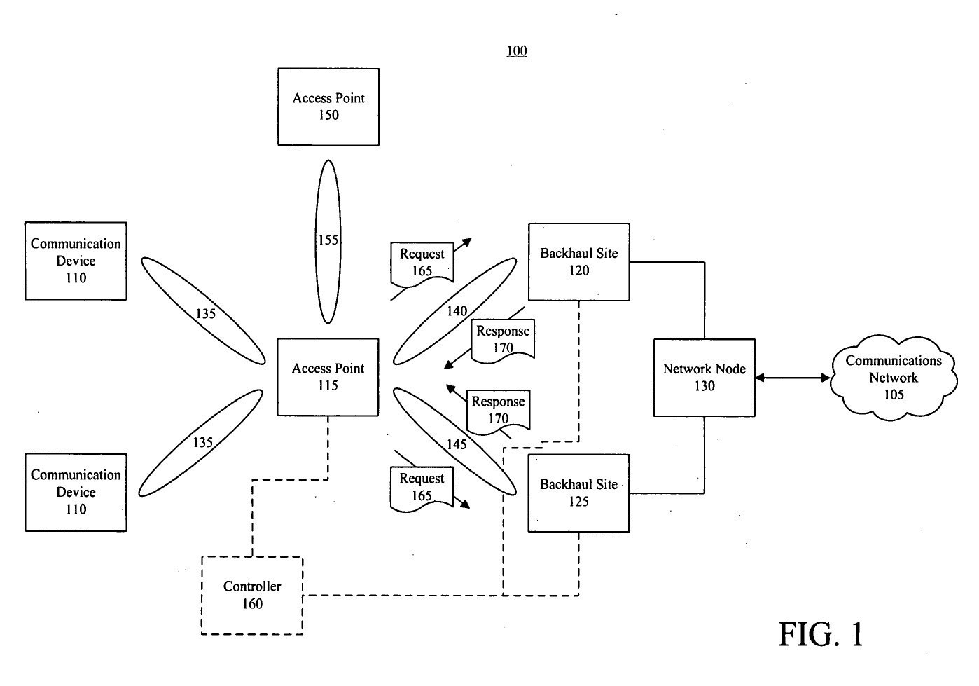

FIG. 1 depicts a communication system 100 that is useful for understanding the present invention. The communication system 100 can communicatively link one or more communication devices 110 to a communications network 105. The communication system 100 can include at least one access point 115, a plurality of spatially diverse backhaul sites 120, 125, and a network node 130. The network node 130 can be, for example, a repeater, a base transceiver station, a router, or any other network device which can communicate data between the backhaul sites 120, 125 and the communications network 105.

The access point 115 can communicate with the communication devices 110 via a wired connection or via groundlinks 135. As used herein, a “groundlink” is a wireless communication link between a network infrastructure node and a wireless communication device that is not part of the network infrastructure. For example, the communication devices 110 can be personal computers, personal digital assistants (PDAs), network appliances, or any other communication devices which are not part of the network infrastructure.

The access point 115 also can communicate with the plurality of backhaul sites 120, 125 via respective wireless backhaul channels 140, 145. As used herein, a “backhaul channel” is a communication link between two network infrastructure nodes. Although two backhaul sites 120, 125 are depicted, the invention is not limited in this regard and any number of backhaul sites can be configured to communicate with the access point 115.

The backhaul sites 120, 125 can be spatially diverse in azimuth and/or in elevation. For example, the backhaul site 120 can be positioned on top of a tall building and the backhaul site 125 can be positioned on a rooftop. The access point 115 can include a phased array to beam steer, both in azimuth and in elevation, RF signals to the respective backhaul sites 120, 125. Similarly, the backhaul sites 120, 125 also can include phased arrays to beam steer RF signals to the access point 115.

In addition, the phased arrays also can be used to dynamically implement spatial diversity and/or polarization diversity, for example when improved signal quality is desired. For instance, spatial diversity and/or polarization diversity can be implemented when the signal to noise ratio (SNR) or bit error rate of a signal exceeds a threshold value, the signal receive power drops below a threshold value, or if any other undesirable signal conditions exists.

Spatial diversity can be implemented by simultaneously transmitting backhaul signals from the access point 115 to multiple backhaul sites 120, 125. Data contained in the backhaul signals can be propagated to the network node 130, which can process the data from the backhaul signals that exhibit the best signal quality in comparison to the other backhaul signals. Similarly, when the access point 115 is receiving spatially diverse backhaul signals from multiple backhaul sites 120, 125, the access point can process data from one or more of the backhaul signals that exhibit the best signal quality in comparison to the other backhaul signals. As part of a data selection process, the network node 130 and the access point 115 can evaluate receive signal strength, data error rates, or any other backhaul signal parameters.

Polarization diversity can be implemented by transmitting multiple backhaul signals having different polarizations over the backhaul channels 140, 145. For example, backhaul signals can be transmitted to a backhaul site 120 with a horizontal polarization, a vertical polarization and/or a circular polarization. The access point 115 or backhaul site 120 receiving the backhaul signals can selectively process one or more of the signals that exhibit the best signal quality in comparison to the other backhaul signals. In one arrangement, both spatial diversity and polarization diversity can be implemented.

In one aspect of the invention, the access point 115 can communicate with other access points, such as access point 150, over a wireless backhaul channel 155. The access point 150 can route signals through the access point 115 to communicate with one or more of the backhaul sites 120, 125. In this manner, even if the access point 150 does not include a phased array, the access point 150 still can benefit from beam steering, spatial diversity and/or polarization diversity implemented by the access point 115.

In operation, the access point 115 can dynamically select an available backhaul site, for example backhaul site 120, with which to communicate. The selection process can be triggered in response to a wireless communication device 110 establishing a communication link with the access point 115, in response to inadequate bandwidth availability on a backhaul site 125 with which the access point 115 is currently communicating, in response to a session timeout, in response to excess interference generated by a backhaul site, or in response to any other circumstance.

The dynamic selection of an available backhaul site can include determining which backhaul sites 120, 125 of those configured to communicate with the access point 115 are likely to have adequate bandwidth capability. Such a determination can be made in any suitable manner. For instance, the access point 115 can reference a list of backhaul sites 120, 125 that are configured to communicate with the access point 115. The list can include a bandwidth indicator for each backhaul site 120, 125. For example, the backhaul sites 120, 125 can be categorized as high bandwidth (e.g. having a fiber optic connection to the network node 130), medium bandwidth (e.g. having a T-1 connection to the network node 130) or low bandwidth (e.g. having an ISDN or cable connection to the network node 130).

The list can be stored in access point 115 or stored at a location readily accessible to the access point 115. For instance, the list can be stored on a controller 160 to which the access point 115 is communicatively linked. The list can be automatically updated or manually updated each time a backhaul site 120, 125 is added or removed from the communication system 100, or periodically updated. In another arrangement, a backhaul site 120, 125 can propagate an online/offline indicator to the access point 115 each time such a backhaul site is brought online or taken offline. The online/offline indicator can trigger the access point 115 to update the list. In yet another arrangement, the access point 115 can periodically scan for backhaul sites 120, 125 and update the list by adding those backhaul sites that are online and removing from the list backhaul sites 120, 125 that are offline.

After identifying the backhaul sites 120, 125 that are likely to have adequate bandwidth capability, an evaluation can be made to identify which of those are available to support backhaul communications with the access point 115. For example, the access point 115 can send a request 165 to each of the identified backhaul sites 120, 125. The backhaul sites 120, 125 can reply to the requests 165 with responses 170 that indicate whether the respective backhaul sites 120, 125 are available to the access point 115 and, if so, how much of their total bandwidth is currently available and/or anticipated to be available for use by the access point 115.

In another arrangement, the access point 115 can search for available backhaul sites 120, 125. For instance, the access point 115 can scan for potentially available backhaul sites 120, 125 in azimuth and/or elevation and add such sites to a list of potentially available backhaul sites. The access point 115 then can identify which of the sites 120, 125 on the list are likely to have adequate bandwidth capability. The access point 115 can identify such sites in any suitable manner. For example, for each backhaul site 120, 125 discovered during the scanning process, the access point 115 can send a request 165. The backhaul sites 120, 125 can respond to such requests with an indication of the bandwidth available to the access point 115 as previously described.

The available bandwidth from each backhaul site 120, 125 can be determined based upon one or more parameters. For example, the available bandwidth from each backhaul site 120, 125 can be a total amount of anticipated available bandwidth. The anticipated available bandwidth can be determined by evaluating historical data pertaining to temporal traffic patterns. For example, average and peak backhaul load levels with respect to time can be evaluated. A time frame for the evaluation can be a time of day, a day of the week, a day of the year, a week, a month, a season, or any other desired time frame. Greater emphasis can be placed on more recent loading trends.

The bandwidth available to the access point 115 can be based on other parameters as well. For example, the available bandwidth also can be based on the priority assigned to the access point 115 and collective needs of the communication system 100 and/or the communications network 105. Network priority levels can be assigned to various access points 115 and/or communication devices 110 in the communication system 100. For instance, access points 115 that are used by emergency responders, such as the military, law enforcement agencies, fire/rescue services and hospitals, can be assigned highest priority. Access points 115 used by non-emergency government agencies can be assigned a second highest priority, businesses can be assigned a third highest priority, and home users can be assigned a fourth highest priority. Still, other priority allocation schemes can be implemented and the invention is not limited in this regard.

The network priorities can be evaluated when determining bandwidth availability. For example, if the access point 115 has a priority level higher than other access points that are currently communicating via the backhaul site 120, the response 170 from the backhaul site 120 can indicate that at least a portion of that backhaul site's bandwidth is available to the access point 115. The indicated portion can include bandwidth that is presently allocated to the other access points which have lower priority than the access point 115. If, however, the access point 115 has a lowest level of priority and most of the backhaul site's bandwidth is already allocated to other access points, the response 170 can indicate that the backhaul site 120 is not currently available to the access point 115.

The access point 115 can process the responses 170 to evaluate the bandwidth indicated as being available from each of the respective backhaul sites 120, 125, and then select at least one of such backhaul sites 120, 125 with which to communicate. For example, assume that the access point 115 requires 1 Mb/s of bandwidth. If the response 170 received from the backhaul site 120 indicates that it can allocate up to 2 Mb/s to the access point 115, and the response 170 received from the backhaul site 125 indicates that it can allocate up to 500 kb/s, the access point 115 can select the backhaul site 120. If, on the other hand, the responses 170 indicate that a plurality of backhaul sites 120, 125 have at least 1 Mb/s available to the access point 115, the access point 115 can select the backhaul site 120 with which it is most proximately located. If that backhaul site 120 is already heavily loaded, the backhaul site 120 can allocate the requested bandwidth to the access point 115 from other access points having lower priority than the access point 115. Access points from which bandwidth is reallocated can select other backhaul sites through which to communicate backhaul signals.

In another arrangement, backhaul selection and allocation can be implemented by a centralized controller, such as the controller 160. The controller 160 can maintain a list of backhaul sites 120, 125 and access points. If a priority allocation scheme is used, the controller 160 also can associate priority levels with the access point 115, other access points and/or the wireless devices 110. The controller can receive backhaul loading information from the respective backhaul sites 120, 125 and receive requests for backhaul channels 140, 145 from the access point 115. The controller 160 can process the requests and propagate control signals to the access point and backhaul sites 120, 125 as required to control communications traffic in the communication system 100. The requests, backhaul loading information and control signals can be propagated using relatively little bandwidth. Accordingly, the access point 115 and the backhaul sites 120, 125 can communicate with the controller 160 over any available communication link, for example using narrowband RF communications or using telephone lines.

The geometrical patterns formed by nodes of the communication system 100 can be dynamically changing. For example, access points 115, backhaul sites 120, 125, mobile communication devices 110 and other network components can be added and removed from the network at any time. Advantageously, the communication system 100 can dynamically adjust backhaul allocations based on the changing geometries of the communication system 100. Indeed, the controller 160 and/or the access point 115 can receive a node change indicator each time a node is added to, or removed from, the communication system 100. The controller 160 and/or access point 115 can dynamically update a geographical mapping of the communication system 100 and evaluate geometrical traffic patterns, along with temporal traffic patterns, within the communication system 100 to determine the bandwidth to allocate to the access point 115 from one or more backhaul sites 120, 125. For example, the controller 160 (or the access point 115) can allocate backhaul sites 120, 125 to the access point 115 in a manner that balances backhaul loads across a geographic area served by the controller 160.

In one aspect of the invention, the backhaul sites 120, 125 may be installed at different elevations. For example, a high bandwidth backhaul site may be installed at the top of a tall building or tower, a medium bandwidth backhaul site may be installed on a telephone pole, and a low bandwidth backhaul site may be installed inside a building. The controller 160 and/or the access point 115 can be configured to direct as much traffic as possible to the low bandwidth backhaul sites, reserving the high bandwidth backhaul sites exclusively for high bandwidth requirements and for congestion relief when the low bandwidth backhaul sites become overly congested. The controller 160 and/or the access point 115 may also be configured to direct traffic to/from a backhaul site 120, 125 to minimize interference with other access points, other backhaul sites, or other communication devices 100 served by the access point 115 or served by other access points. As an example, RF transmissions to a higher elevation backhaul site may generate less interference than RF transmissions to a lower elevation backhaul site.

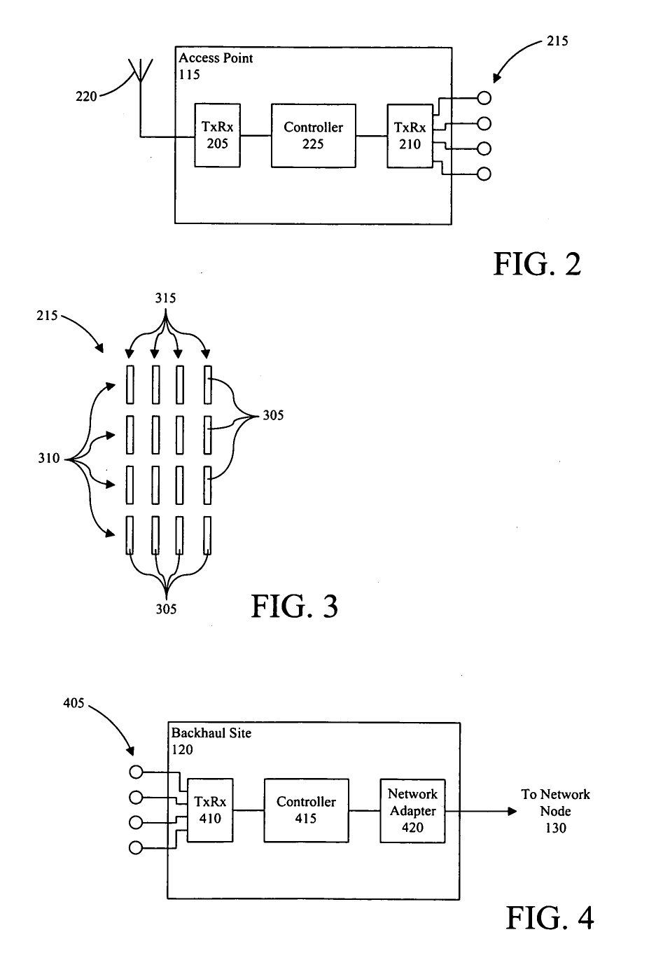

FIG. 2 depicts an example of the access point 115 that is useful for understanding the invention. The access point 115 can include at least one transceiver 205 to support groundlink communications. The transceiver 205 can be, for example, a software defined radio. Software defined radios are known to the skilled artisan. The transceiver 205 can support Global System for Mobile Communication (GSM) wireless communications, frequency division multiple access (FDMA), time division multiple access (TDMA), code division multiple access (CDMA), wideband code division multiple access (WCDMA), orthogonal frequency division multiple access (OFDMA), any of the IEEE 802 wireless network protocols (e.g. 802.11 a/b/g/i, 802.15, 802.16, 802.20), Wi-Fi Protected Access (WPA), WPA2, or any other wireless communications protocol implemented by the communications network. In another arrangement the access point 115 can include a communications port (not shown) for communicating with the communication device over a wired communications link. The communications port can be a network adapter, a serial communications port, a parallel communications port, or any other suitable port that supports wired communications.

The access point 115 also can include at least one backhaul transceiver 210 to support backhaul communications with the backhaul sites. The backhaul transceiver 210 can be, for example, a software defined radio. In the arrangement shown, a single multi-channel backhaul transceiver 210 can be implemented to support communication on multiple backhaul channels or to support dynamic polarization diversity. In an alternate arrangement, the functionality of both the transceiver 205 and the backhaul transceiver 210 can be implemented by a single transceiver. In yet another arrangement, the access point 115 can include a first transceiver to support communications on the first backhaul channel and a second transceiver to support communications on the second backhaul channel. Still, any number of transceivers can be included in the access point 115 and the invention is not limited in this regard.

To facilitate communication over the spatially diverse backhaul channels and/or to support multiple backhaul signal polarizations, the access point 115 can include a phased array 215. Such an array 215 may be designed to provide a fixed set of beams aimed in specific, desired directions, or the array may be fully adaptive (i.e. smart antenna) to permit beams formed to be aimed in any direction within the design constraints of the array 215. In one arrangement, the array 215 also can support groundlink communications with the communications devices. In an alternate arrangement, an antenna 220 can be provided to support groundlink communications. The antenna 220 can be an omni-directional antenna or a phased array.

The access point 115 can include a controller 225 to control processing of signals received by the backhaul transceiver 210 and to execute other access point computer programs. The controller 225 also can indicate to the backhaul transceiver 210 to beam steer backhaul signals from the access point 115 to the selected backhaul site(s). For example, the controller 225 can send control signals to the backhaul transceiver 210 that indicate the direction in which to beam steer the phased array 215. Such control can be implemented both in transmit mode and in receive mode.

In addition, the controller 225 can control sending of the requests to the respective backhaul sites and process the responses. In an arrangement in which the access point 115 implements the process for selecting the backhaul sites with which to communicate, the selection process also can be implemented by the controller 225. For instance, the controller 225 can evaluate the available bandwidth of the individual backhaul sites and select a suitable backhaul site with which to communicate backhaul signals, or a plurality of suitable backhaul sites if implementing spatial diversity for the backhaul signals. As part of the selection process for the backhaul site, the controller 225 also can receive backhaul loading information and evaluate the temporal traffic patterns and/or geometrical traffic patterns as previously described.

FIG. 3 depicts a front view of the phased array 215. The phased array 215 can include a plurality of array elements 305 arranged in a multi-dimensional array pattern. For example, the array elements 305 can be arranged to form a plurality of array rows 310 and a plurality of array columns 315. The number of elements 305 in the rows 310 and columns 315 can determine the specific antenna characteristics, such as the antenna gain and width of the beam that is formed.

The phased array 215 can both beam form backhaul signals being transmitted to the backhaul sites and focus reception onto signals being received from the backhaul sites. For example, in the transmit mode, the phase and power level of individual backhaul signal components applied to array elements 305 in particular columns 315 can be controlled to beam steer backhaul signals in azimuth. The phase and power level of individual backhaul signal components applied to array elements 305 in particular rows 310 can be controlled to beam steer backhaul signals in elevation. In the receive mode, phase delay and attenuation can be selectively applied to signals received by the respective array elements 305 to beam steer backhaul signal reception both in azimuth and in elevation.

In addition, the signals applied to and received from the array elements 305 can be dynamically controlled to support any of a variety of polarization options. Examples of such polarization options can include vertical polarization, horizontal polarization, right hand circular polarization, left hand circular polarization or slant polarization. Nonetheless, the invention is not limited in this regard and the array elements 305 can be dynamically controlled to support any other desired polarization.

FIG. 4 depicts an example of the backhaul site 120 that is useful for understanding the present invention. The backhaul site 120 can include a phased array 405, a transceiver 410 and a controller 415. Functionality of these components can be similar to those functions previously described for the access point, although backhaul specific computer programs can be processed by the controller 415. For example, the controller 415 can generate responses to the requests received from the access point. The backhaul site 120 also can include a network adapter 420 for communicating with the network node 130. The network adapter 420 can be a wired or wireless network adapter suitable for communicating in accordance with the communications protocol implemented by the communication system. In the case that the backhaul site 120 is wirelessly connected to the network node, functionality of the network adapter 420 can be implemented by the transceiver 410, and the array 405 can be used to communicate signals to the network node.

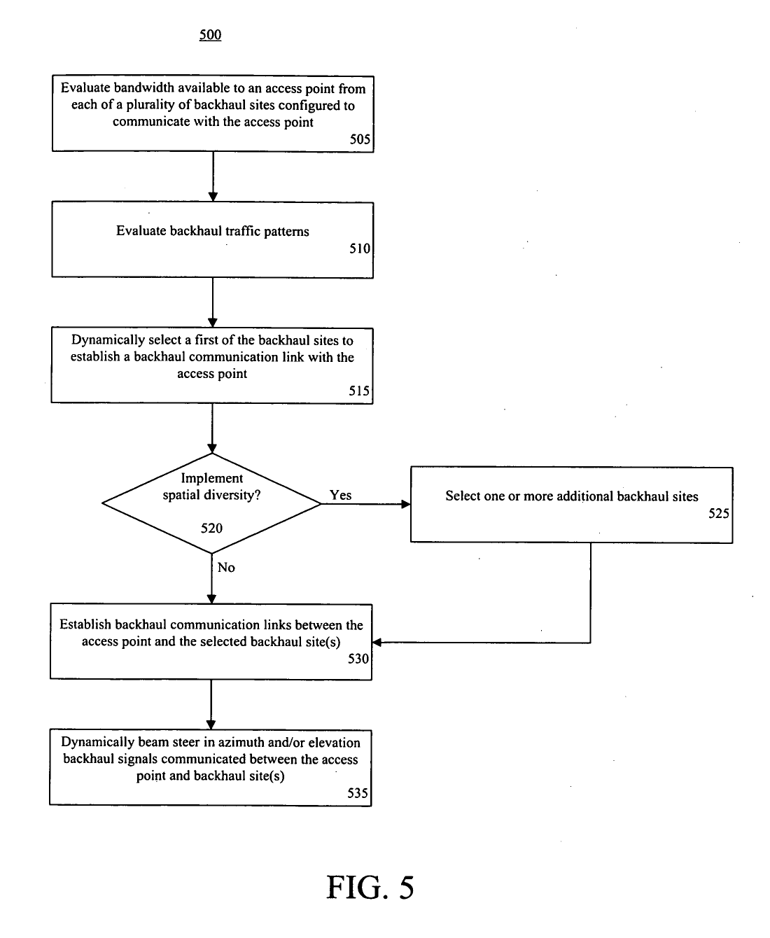

FIG. 5 depicts a flowchart presenting a communication method 500 that is useful for understanding the present invention. Beginning at step 505, bandwidth available to an access point from each of a plurality of backhaul sites, each of which are configured to communicate with the access point, can be evaluated. At step 510, backhaul traffic patterns also can be evaluated. For example, temporal traffic patterns and/or geometrical traffic patterns within a communication system and/or communications network can be evaluated. Proceeding to step 515, a first backhaul site can be dynamically selected to establish a backhaul communication link with the access point. The first backhaul site can be selected from the plurality of backhaul sites configured to communicate with the access point. Referring to decision box 520 and step 525, one or more additional backhaul sites can be selected if spatial diversity is to be implemented. Continuing to step 530, backhaul communication links can be established between the access point and the selected backhaul site(s). At step 535, backhaul signals communicated between the access point and the backhaul site(s) can be beam steered in azimuth and/or elevation. In one arrangement, polarization diversity can be implemented for the backhaul signals.

Control functions of the present invention can be realized in hardware, software, or a combination of hardware and software. These control functions can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. An example of such a processing system can be the controller 160 of FIG. 1 and/or the controller 225 of FIG. 2. The present invention also can be embedded in an application product, which comprises all the features enabling the implementation of the methods described herein, and which when loaded in a processing system is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the sperit or essential attributes thereof. Accordingly, reference should be made to the following claims, rather than to the foregoing specification, as indicating the scope of the invention.

What is claimed is:

1. A method of communicating backhaul data comprising:
from a plurality of backhaul sites that are each configured to wirelessly communicate with an access point, dynamically selecting a first backhaul site to establish a backhaul communication link with the access point; and
dynamically beam steering backhaul signals communicated between the access point and the backhaul site.

2. The method according to claim 1, wherein dynamically beam steering the backhaul signals comprises beam steering the backhaul signals to at least one directional coordinate selected from the group consisting of an azimuth and an elevation.

3. The method according to claim 1, wherein dynamically selecting the first backhaul site comprises evaluating available bandwidth on each of the plurality of backhaul sites.

4. The method according to claim 1, wherein dynamically selecting the first backhaul site comprises evaluating a temporal traffic pattern of backhaul communications.

5. The method according to claim 1, wherein dynamically selecting the first backhaul site comprises evaluating a geometrical traffic pattern of backhaul communications.

6. The method according to claim 1, wherein dynamically selecting the first backhaul site comprises evaluating a priority level of at least one network node selected from the group consisting of the access point and a communication device.

7. The method according to claim 1, further comprising implementing diversity for the backhaul signals communicated between the access point and the backhaul site.

8. The method according to claim 7, wherein implementing diversity for the backhaul signals comprises implementing at least one diversity scheme selected from the group consisting of polarization diversity and spatial diversity.

9. A communication system comprising:
an access point comprising a phased array that dynamically beam steers backhaul signals;
a plurality of backhaul sites that are each configured to wirelessly communicate with the access point; and
a controller that dynamically selects from the plurality of backhaul sites at least a first backhaul site to establish a backhaul communication link with the access point, and generates a control signal that indicates to the access point to beam steer a backhaul signal to the first backhaul site.

10. The communication system of claim 9, wherein the phased array dynamically steers the backhaul signals to at least one directional coordinate selected from the group consisting of an azimuth and an elevation.

11. The communication system of claim 9, wherein the controller evaluates available bandwidth on each of the plurality of backhaul sites.

12. The communication system of claim 9, wherein the controller evaluates a temporal traffic pattern of backhaul communications.

13. The communication system of claim 9, wherein the controller evaluates a geometrical traffic pattern of backhaul communications.

14. The communication system of claim 9, wherein the controller evaluates a priority level of at least one network node selected from the group consisting of the access point and a communication device.

15. The communication system of claim 9, wherein the access point implements diversity for the backhaul signals communicated between the access point and the backhaul site.

16. The communication system of claim 15, wherein the diversity that is implemented comprises at least one diversity scheme selected from the group consisting of polarization diversity and spatial diversity.

17. A machine readable storage having stored thereon a computer program having a plurality of code sections comprising:
code for dynamically selecting a first backhaul site to establish a backhaul communication link with an access point, the first backhaul site selected from a plurality of backhaul sites that are each configured to wirelessly communicate with the access point; and
code for dynamically beam steering backhaul signals communicated between the access point and the backhaul site.

18. The machine readable storage of claim 17, wherein the code for dynamically beam steering the backhaul signals further comprises code for beam steering the backhaul signals to at least one directional coordinate selected from the group consisting of an azimuth and an elevation.

19. The machine readable storage of claim 17, wherein the code for dynamically selecting the first backhaul site further comprises code for evaluating a temporal traffic pattern of backhaul communications.

20. The machine readable storage of claim 17, wherein the code for dynamically selecting the first backhaul site further comprises code for evaluating a geometrical traffic pattern of backhaul communications.
